(19) United States
(12) Patent Application Publication
(10) Pub. No.: US 2014/0260975 A1
(43) Pub. Date: Sep. 18, 2014

(54) Quick Switch Pollution Control System for Vacuum Truck Operation

(71) Applicant: Charles K. Miller, Corpus Christi, TX (US)

(72) Inventor: Charles K. Miller, Corpus Christi, TX (US)

(21) Appl. No.: 13/826,312

(22) Filed: Mar. 14, 2013

(51) Int. Cl. B01D 53/04; B01D 53/14

(52) U.S. Cl. CPC B01D 53/0446; B01D 53/1487
USPC 95/92; 96/151; 96/243; 96/138; 96/133; 96/131; 95/90; 95/223

(57) ABSTRACT

Vacuum trucks are utilized for collecting liquids and solids capable of fluidization, via a hose or pipe connected to a holding tank in which a vacuum has been induced via an air mover such as a blower. The air stream drawn from the holding tank must be discharged to the atmosphere; environmental laws may require treatment of the exhaust stream prior to discharge. Vacuum trucks used in industrial settings like petroleum refineries and chemical plants may require a large charge of materials to remove pollutants discharged from the vacuum truck holding tank. The embodiments disclosed herein include modularized “control units,” containing adsorbents and/or absorbents to reduce the organic content of the exhaust gas, including VOCs as well as specific organic compounds of concern. These materials must be replaced when they are no longer effective in removing pollutants. Embodiments herein include a system for efficient change out of control units to allow continued operation. This apparatus and method allows for the change out of the control units at the location or site of the operation of the vacuum unit rather than requiring return to a service point.

Embodiments disclosed herein may be used for to control organic pollutants in an exhaust stream from the holding tank of a vacuum truck. Vacuum trucks are utilized for collecting liquids and solids capable of fluidization, via a hose or pipe connected to a holding tank in which a vacuum has been induced via an air mover such as a blower. The air stream drawn from the holding tank must be discharged to the atmosphere; environmental laws may require treatment of the exhaust stream prior to discharge. Many times the collected liquid is organic in nature or contains organic materials. Of concern is a general class of volatile organic compounds (VOCs) and specific compounds such as benzene. The embodiments disclosed herein include modularized “control units,” containing adsorbents and/or absorbents to reduce the organic content of the exhaust gas, including VOCs as well as specific organic compounds of concern.

It is well known that low vapor pressure organic liquids (like diesel) and activated carbon are effective at reducing the organic content of a vent gas. Ultimately, absorbents and adsorbents become saturated with organic contaminants and must be replaced. Embodiments herein include a system for efficient change out of control units to allow continued operation. This apparatus and method allows for the change out of the control units at the location or site of the operation of the vacuum unit rather than requiring return to a service point.

### BRIEF DESCRIPTION OF THE DRAWINGS

FIG. 1 shows a simplified block flow diagram of a vacuum truck.

FIG. 2 shows a flow diagram of the VOC pollution control device.

FIG. 3 shows a partial cross-sectional side view of a single control unit.

FIG. 4 shows a side view of the control panel.

### DETAILED DESCRIPTION

### Parts List

Holding tank 100
Holding tank suction line 110
Draining canister 120
Draining canister valve 125
Drained liquid stream 128
Vacuum pump 130
Draining canister 140
Draining canister valve 145
Drained liquid stream 148
VOC pollution control device 150
Final canister 160
Holding tank exhaust 200
Vacuum pump suction 210
Control device inlet 220
Treated exhaust stream 230
Inlet split to Control unit 1 300
Control unit 1 inlet valve 310
Control unit 1 inlet line 320
Inlet 1 flexible hose 330
Outlet 1 flexible hose 340
Outlet 1 Hard pipe 350
Control unit 1 outlet 360
Control unit 1 outlet valve 370
Secondary inlet 380
Inlet split to Control unit 2 400
Control unit 2 inlet valve 410
Control unit 2 inlet line 420
Inlet 2 flexible hose 430
Outlet 2 flexible hose 440
Outlet 2 Hard pipe 450
Control unit 2 outlet 460
Control unit 2 outlet valve 470
Secondary inlet 480
Discharge valve 1 500
Discharge valve 2 510
Control device outlet 520
Control panel 600
Top transport valve 610
Engine Shut off switch 620
Bypass control unit switch 630
Bypass control unit indicator 635
Control unit system switch 640
Control unit 1 primary indicator 643
Control unit 2 primary indicator 648
Rear works light switch 650
Power switch 660
Power indicator 670
Hose 1 inlet connector 700
Hose 1 outlet connector 710
Hose 2 inlet connector 720
Hose 2 outlet connector 730
Hose 3 inlet connector 740
Hose 3 outlet connector 750
Hose 4 inlet connector 760
Hose 4 outlet connector 770
Control unit No. 1 801
Control unit No. 2 802
Control unit 1 vapor in line 811
Control unit 2 vapor in line 812
Control unit diffuser line 820
Control unit screen support 830
Lower Control unit screen 840
Upper hold down screen 845
Control unit liquid drain 850
Control unit liquid 860
Control unit carbon 870
Control unit outlet screen 880
Control unit 1 vapor outlet line 891
Control unit 2 vapor outlet line 892
Control unit base 900
Control unit base forklift inlets 910

Reference is made to FIG. 1 which contains a simple schematic flow diagram of a typical vacuum truck with a control device for the exhaust stream. The purpose of the system is to draw a liquid into the holding tank 100 through a hose or pipe, connected to the holding tank suction line 110. Liquid is induced into the holding tank 100 which is under a vacuum. A vacuum is created in the holding tank 100 by an air mover, blower, or vacuum pump 130 that pulls a stream of air out of the holding tank 100, referred herein as the holding tank exhaust 200. The exhaust stream 200 is routed through a control device 150 and ultimately a treated exhaust stream 230 is discharged to the atmosphere.

The embodiment shown in FIG. 1 contains optional canisters or filters to remove entrained liquids or solids from the exhaust streams. The canisters may be filled with a high surface area material such as a filter material or packing material, or may utilize tangential forces to separate liquids and solids from the exhaust stream. Other means that facilitate separation of liquid and solid material from the exhaust stream may also be used. A draining canister 120 is located upstream of the vacuum pump 130, to provide protection from entrained liquids and solids. The upstream draining canister 120 is equipped with a draining canister valve 125 to facilitate removal of the drained liquid stream 128. An optional draining canister 140 is located downstream of the vacuum pump 130 and is equipped with a draining canister valve 145 to facilitate removal of the drained liquid stream 148. A final canister 160 is located downstream of the control device 150 prior to discharge of the treated exhaust stream 230.

The embodiment presented in FIG. 1 shows the holding tank 100 and control devices 150 attached to a mobile platform that in this example is the flatbed of truck. In other embodiments, some or all of the equipment may be attached to different mobile platforms, such as a skid-mounted deck, capable of transportation.

Referring now to FIG. 2 which shows the VOC pollution control device 150 in greater detail. In the embodiment shown in FIG. 2, the pollution control device 150 contains two control units 801 and 802. The control units contain adsorbent and/or adsorbent media capable of capturing VOCs and specific organic molecules of concern. Although this embodiment presents two control units, the pollution control device 150 may have one or more control units. The number of control units is limited by the pressure drop through the control units at the desired flow rate. As presented in FIG. 2, this embodiment has a valve arrangement that allows for parallel or series flow through control unit no. 1 801 and control unit no. 2 802. Parallel flow may be initiated by opening control unit 1 inlet valve 310, control unit 2 inlet valve 410, discharge valve 1 500, and discharge valve 2 510, while closing control unit 1 outlet valve 370 and control unit 2 outlet valve 470.

Conversely, the control units can operate in series by coordinating the position of the valve (open or closed) according to groups. Group one would include control unit 1 inlet valve 310, control unit 1 outlet valve 370, and discharge valve 1 500. Group two would include control unit 2 inlet valve 410, control unit 2 outlet valve 470, and discharge valve 2 510. Operation of this embodiment in series flow occurs by operating Group one valve in the opposite position from Group two valves. Operation of the Group one valves in the open position (and thus Group two in the closed position) results in control unit no. 1 801 being the primary control unit (i.e., first control unit the series) and control unit no. 2 802 being the secondary control unit (i.e., receives flow from the primary control unit). The order of flow can be changed by reversing the valve positions by closing Group one valves and opening Group two valve. Under this circumstance, control unit no. 2 802 becomes primary and control unit no 1 801 becomes secondary.

Considering FIG. 2 further, flow enters the VOC pollution control device 150 at the control device inlet 220. This line divides so as to allow either series or parallel flow as described previously. One branch is referred to as the inlet split to control unit 1 300 and the other split is referred to as inlet spilt to control unit 2 400. Considering series flow where Group one valves are in the open position, flow or holding tank exhaust 200 is routed to control unit no. 1 801 via control unit inlet valve 310 to control unit 1 inlet line 320; control unit 2 outlet valve 470 is closed.

An important feature of the embodiment shown in FIG. 2 is a piping system configuration that facilitates the “change-out” of a spent control unit. At some point, each the absorbent and/or adsorbent material in the control unit will no longer remove pollutants effectively and will require replacement. Under typical operations, the primary control unit becomes spent first, having the highest loading of organic contaminants, and must be replaced. After the spent control unit is replaced, the truck operator should switch the groups so that the new control unit (now located in the position of the replaced and former primary control unit) becomes the secondary control unit and the (former) secondary control unit becomes the (post-switch) primary control unit.

Continuing with the series flow example, the holding tank exhaust 200 is routed from the control unit inlet line 320 to the inlet 1 flexible hose 330. This hose is connected to the control unit 1 inlet line 320 via the hose 1 inlet connector 700. The outlet of the inlet 1 flexible hose 330 is connected to the control unit 1 vapor in line 811 via the hose 1 outlet connector 710. In this embodiment, vapor enters the bottom of the control unit and exists at the top via the control unit 1 vapor outlet line 891. This line is attached to outlet 1 flexible pipe 340, which is routed via a series of lines shown as the outlet 1 hard pipe 350, control unit no 1 outlet 360 through an open control unit no. 1 outlet valve 370 to the secondary inlet 380; in this example, discharge valve 2 510 is closed. The control unit inlet valve 410 is shut, forcing flow through control unit no. 2 802 (which in this example is a secondary control unit). Flow proceeds through control unit no. 2 802 through the control unit 2 inlet line 420, through the inlet 2 flexible hose 430, entering the bottom and exiting the top of control unit no. 2 802, passing through the outlet 2 flexible hose 440 to the outlet 2 hard pipe to discharge valve no. 1 500 (given that control unit 2 outlet valve 470 and discharge valve 2 510 are closed). Flow from the pollution control device 150 exits via the control device outlet 520.

While the above description illustrates one configuration of how the function of two control units may be coordinated; other combinations may allow for the same function, and in many instances specific pieces of pipe could be eliminated, simplifying the system. For example, outlet 1 flexible hose could be coupled directly to control unit 1 outlet 360 without first passing through outlet 1 hard pipe 350. In all cases hard pipes may be substituted with flexible pipe/hoses and vice versa. Configuration with a single control unit would be significantly simplified and configurations with more than two control units would become more involved.

Reference is now made to FIG. 3 which shows a control unit in greater detail. Control units may be identically configured or may be differently configured. In this example, control unit no. 1 801 and control unit no. 2 802 are similarly configured. Vapor enters the control unit via an internal control unit diffuser line 820. The control unit contains an absorbent liquid designated as control unit liquid 860. A purpose of the liquid is to capture entrained or condensed liquids prior to proceeding to the control unit carbon 870 (which is supported by the control unit screen support 830 and the lower control unit screen 840 and optionally retained by an upper hold down screen 845), so as to prolong the useful life of the carbon bed.

Proper selection of the nature and composition of the control unit liquid 860 is dependent on the nature of the material being recovered by the vacuum truck. A simple low vapor pressure organic mixture, such as diesel, is appropriate where recovering an organic material, or another material that contains organic contaminants. Other organic liquids may be used for the same purpose. In another example, the control unit liquid 860 may be or contain a surfactant or degassing chemical. In another example, the control unit liquid 860 may be a caustic solution or another chemical capable of removing inorganic substances such as hydrogen sulfide. In yet another example, the control unit liquid 860 could be an aqueous solution, adjusted to a desired pH, with or without addition of surfactants. Ultimately, the purpose of the control unit liquid is the removal of contaminants that shorten the life of the carbon bed.

Vapor, after passing through the control unit liquid 860 and the control unit carbon 870, exits the control unit via the vapor outlet line, being 891 for the control unit 1 outlet vapor line and 892 for the control unit 2 vapor outlet line. The vapor outlet line may be equipped with a control unit outlet screen 880 to hold back solid material (such as carbon). Control units may be configured as described above with a control unit liquid 860 and carbon 870, or alternatively with control unit liquid 860 only, or carbon 870 only.

Reference is now made to FIG. 4 which shows the control panel. Although the system of valves discussed previously could be operated manually, one embodiment includes a control system to coordinate the valves and monitor the operation of the system. In this embodiment, power is enabled to the control system via power switch 660 and indicated by power indicator 670. The rear lights work light switch 650 activates the rear working lights. The control unit system switch 640 coordinates the valve groups so a designate which control unit is primary and which is secondary. In this embodiment, control unit no. 1 801 is the primary control unit when the control unit 1 primary indicator 643 is activated. Likewise, control unit no. 2 802 is the primary control unit when the control unit 2 primary indicator 648 is activated. In this embodiment, the control system also allows complete bypass of the pollution control device 150 via the bypass control unit switch 630 as indicated by the bypass control unit indicator 635. The control panel in this embodiment has a switch to close the top transport valve 610 and an emergency engine shut-off 620. The top transport valve 610 should be secured prior to transporting a vacuum truck containing a load of received liquid. The emergency shut off 620 is used to shut of air from the engine in an emergency.

One embodiment of the apparatus described herein is configured with at least two control units. The exhaust stream leaving the tank is initially routed to the (primary) control unit that is closest to being spent. The partially treated steam exits the initial control unit and is routed to the inlet of the “fresher” (secondary) control unit. The secondary control unit is fresher because it has adsorbed and/or absorbed less organic material. At some point in time, the primary control unit, having practically exhausted its adsorption and/or adsorption capacity, becomes spent and must be replaced.

Vacuum trucks with VOC pollution control devices already exist. See U.S. Pat. No. 7,147,689 (filed Apr. 30, 2004) (issued Dec. 12, 2006). Embodiments disclosed herein have similarities to these inventions as both allow for operation of the vacuum truck with reduced emissions of VOCs. Effective control systems, designed to remove VOCs based on absorption with organic liquids or adsorption with activated carbon, have inherent limitations. “Break-through” of the organic vapors occurs when the holding capacity of the oil and/or carbon reaches a certain level. Where an emission limit is reached, upon beak-through, it is necessary for the vacuum truck to stop operation and return to servicing point (often offsite) for a fresh charge of adsorbent and/or absorbent.

Efficient utilization of vacuum trucks, where requirements for a high degree of VOC removal is required, requires relative large charges of VOC adsorption and/or absorption materials to operate for significant periods of time. For a given load of adsorbent/absorbent, the time of satisfactory operation is dependent on the nature and content of the organic vapors being treated and the required discharge quality. It is often desirable that the control units have sufficient capacity to meet objective criteria for a minimum of an eight to twelve hour shift. Control units installed on vacuum trucks in industrial (e.g., petroleum or chemical facility) service may be substantial in size in order to meet environmental requirements. In one embodiment, a fully charge control unit may contain both a thousand or more pounds of carbon and another thousand or more pounds of liquid. Such control units require mechanical means for replacement.

One method of servicing the vacuum truck VOC control system would be to return to a central servicing point where the adsorption/absorption material is removed and replaced with fresh material. Such requires travel to the central servicing location resulting in a loss of operating time due to the unavailability of the vacuum truck. Availability of a systematic, modularized, and quick method of changing control units, at the location of the vacuum truck's operation would significantly reduce downtime and unavailability of vacuum trucks. Embodiments herein include a system for efficient change out of control units to allow continued operation at the location or site of the required work.

At times, it is necessary to operate a multistage system to meet environmental requirements. In a two stage system, after use for a period of time, the second stage (also known as the secondary stage) may have insufficient adsorption/absorption capacity to “polish off” the final discharge to meet discharge concentration/mass limitations; however it may have sufficient capacity remaining to act as the primary control unit. Embodiments contain herein allow for switching of control units from secondary to primary, while adding a fresh control unit (in place of the formally spent primary control unit) that is inserted in the pollution control device 150 to be the “new” secondary control unit. Such allows for maximum utilization of adsorption/absorption material prior to removal/disposal. The inability of systems to efficiently and quickly replace only the spent control unit adds to inefficiency in the system. When it is necessary to move the vacuum truck to an off-site location, overriding time constraints could cause the operator to dump and replace both the primary and secondary control unit, even though the secondary control unit may have some useful life, to minimize future downtime, resulting in an incomplete use of the media in the secondary control unit.

Configured as previously described, the apparatus and methods described herein facilitate the quick switching of individual control units. Prior to switching out the spent control unit for a fresh control unit, the system should be powered down by switching-off power to the system, in this embodiment via power switch 660. After preparation efforts, the first step in the quick switch control unit change out procedure (i.e., replacing the spent control unit) is to switch the primary control unit flow by switching the valve arrangement via the control unit system switch 640 such that the holding tank exhaust stream 200 is moved from the inlet of the spent control unit to the inlet of the other, fresher control unit. After switch the positions of the valves, the (former) secondary control unit become the (post-switch) primary control unit.

The second step in the quick switch control unit change out procedure is to physically disconnect the spent control unit from the connection to the mobile platform (such as the flatbed of the truck). As shown in FIG. 3, each control unit has a control unit base 900. This base is attached to the mobile platform in a secure, yet easy to release manner. In this embodiment, two rectangular metal strips are permanently attached in the vertical position or perpendicular to the mobile platform to position and secure the control unit base 900. These two metal strips are parallel to each other and separated by a distance just greater than the horizontal distance of the control unit base 900. The two parallel metal strips are at least as tall as the vertical height of the control unit base 900 and may have a horizontal plate attached to the highest part of the metal strip to function as a hold-down plate. This hold-down plate is parallel to the mobile platform and perpendicular to the metal strip. The control unit base is further secured via a latch that is secured to the mobile platform and either bolts directly to the control unit base 900, or reaches across the control unit base and attaches to another location on the mobile platform. As described in the above example, the means of attachment between the control unit and the mobile platform is temporary yet secure.

The third step in the quick switch control unit change out procedure is to disconnect the vapor inlet and vapor outlet hoses connections, shown in FIG. 2 as connections 710 and 720, or 750 and 760, depending on whether control unit no. 1 801 or control unit no. 2 802 is being removed. After the control unit base 900 and associated hoses have been disconnected, the spent control unit may be removed from the flatbed of the vacuum truck.

The fourth step in the quick switch control unit change out procedure is to remove the spent control unit. In this embodiment, as shown in FIG. 3, the spent control unit is equipped with forklift inlets 910 in the base 900 so as to facilitate removal from the vacuum truck flatbed via a fork lift. Other methods of removing the spent control unit may be used such as configuring the control unit with secure fixtures to facilitate removal with a lifting line.

The fifth step in the quick switch control unit change out procedure is to install a clean control unit in the place of the spent (and now removed) control unit. The new control unit is put in place by actions reverse to methods described previously for removal of the spent control unit. After being placed in the location previously held by the spent control unit, the base 900 of the fresh control unit is secured to the flatbed of the vacuum truck as described previously.

The sixth step in the quick switch control unit change out procedure is to reconnect the vapor-in and vapor-out hose connections. At this point, the spent control unit has been removed and replaced with a new control unit. Since the primary control unit flow was reversed in step one, the fresh control unit is secondary and the remaining control unit is now primary. The system is now ready for activation.

We claim:

1. An apparatus for vacuuming solid and liquid material, said apparatus comprising:
a. a tank mounted on a mobile platform;
b. a vacuum system in fluid communication with said tank, wherein said vacuum system pulls a vapor from said tank, causing said tank to be at a pressure less than atmospheric, providing a motive force to cause a solid or liquid material, external to said tank, to enter said tank, wherein said solid or liquid material will remain in said tank but said vapor is rejected from said tank;
c. wherein said vapor rejected from said tank is primarily air or an inert gas and said vapor contains non-air, non-inert gas contaminants;
d. a pollution control device, in fluid communication with said tank, comprising at least one control unit containing material capable of removing said contaminants from said vapor rejected from said tank, where said control unit is connected by temporary attachment means to said tank and said mobile platform;
e. wherein said material capable of removing said contaminants may be an absorbent material, an adsorbent material, or a combination of absorbent and adsorbent material; and
f. wherein said at least one control unit is adapted to be replaceable by disconnecting the temporary attachment means from said tank and said mobile platform, removing said at least one control unit, and installing a new at least one control unit, and reattaching said temporary attachment means to said tank and mobile platform.

2. The apparatus of claim 1, further comprising two control units.

3. The apparatus of claim 1 wherein said material capable of removing said contaminants from said vapor is said absorbent material selected from the group consisting of an organic liquid, a caustic solution, or an aqueous solution.

4. The apparatus of claim 1 wherein said contaminant is an organic contaminant and said material capable of removing said contaminant from said vapor is said combination of said absorbent and said adsorbent material, and wherein said absorbent material is an organic liquid and said adsorbent material is an activated carbon.

5. The apparatus of claim 3 wherein said adsorbent material capable of removing said contaminant from said vapor is activated carbon.

6. The apparatus of claim 5 wherein said at least one control unit has a vapor inlet located at a bottom of said at least one control unit, and a vapor outlet located at a top of said at least one control unit, wherein said absorbent material is located in a bottom portion of said at least one control unit, and said activated carbon is located in a top portion of said at least one control unit.

7. An apparatus for vacuuming solid and liquid material, said apparatus comprising:
a. a tank mounted on a mobile platform;
b. a vacuum system in fluid communication with said tank, wherein said vacuum system pulls a vapor from said tank, causing said tank to be at a pressure less than atmospheric, providing a motive force to cause a solid or liquid material, external to said tank, to enter said tank, wherein said solid or liquid material will remain in said tank but said vapor is rejected from said tank;
c. wherein said vapor rejected from said tank is primarily air or an inert gas and said vapor contains non-air, non-inert gas contaminants;
d. a pollution control device, in fluid communication with said tank and having a treated exhaust vent, comprising at least two control units, each said control unit containing a material capable of removing said contaminants from said vapor rejected from said tank, wherein said pollution control device is connected by temporary attachment means to said tank, said treated exhaust vent, and said mobile platform;
e. wherein said material capable of removing said contaminants may be an absorbent material, an adsorbent material, or a combination of absorbent and adsorbent material;
f. wherein said temporary attachment means and said treated exhaust vent comprises a piping system configured to allow operation of said control units in parallel or series;
g. wherein said piping system is adapted to allow one of said at least two control units to be a first control unit and receive the said vapor from the tank and another of said at least two control units to be a second control unit and receive a partially treated vapor from said first control unit; and
h. wherein said piping system is adapted to allow the reversal of the order of flow, resulting in said second control unit receiving said vapor from said tank and said first control unit receiving partially treated vapor from said second control unit.

8. The apparatus of claim 7 adapted such that said at least two control units may be replaced by disconnecting said temporary attachment means from said tank, said treated exhaust vent, and said mobile platform, removing one of said at least two control units, installing a new control unit, and reattaching said temporary attachment means to said tank, said treated exhaust vent, and said mobile platform.

9. The apparatus of claim 7 wherein the material capable of removing said contaminants from said vapor is said absorbent material selected from the group consisting of an organic liquid, a caustic solution, and an aqueous solution.

10. The apparatus of claim 7 wherein said contaminant is an organic contaminant and said material capable of removing said contaminant from said vapor is said combination of absorbent and adsorbent material, and wherein said absorbent material is an organic liquid and said adsorbent material is an activated carbon.

11. The apparatus of claim 9 wherein said adsorbent material capable of removing said contaminant from said vapor is activated carbon.

12. The apparatus of claim 11 wherein said at least two control units have a vapor inlet located at a bottom of each said at least two control units, and a vapor outlet located at a top of each of said at least two control units, wherein said absorbent material is located in a bottom portion of each said at least two control units, and the carbon is located in a top portion of each of said at least two control units.

13. A method for vacuuming solid and liquid material, comprising:
a. providing an apparatus comprising:
i. a tank, a treated exhaust vent, a mobile platform, a pollution control device consisting of a first control unit and a second control unit, and a replacement control unit;
ii. wherein said first and second control units contain a material capable of removing contaminants from an exhaust stream from said tank;
iii. wherein said material capable of removing said contaminants may be an absorbent material, an adsorbent material, or a combination of absorbent and adsorbent material;
iv. temporary means for fluid communication between said tank and said pollution control device, temporary means for fluid communication between said pollution control device and said treated exhaust vent, and temporary attachment means between said pollution control device and said mobile platform, wherein said temporary means for communication consist of flexible hoses, valves, and connectors;
v. wherein said first and second control units remove said contaminants from said vent stream leaving said tank, wherein said first control unit and said second control unit are operated in series; and
vi. wherein said valves in said temporary means for communication are configured to allow either said first control unit or said second control unit to be a primary control unit and receive said vent gas from said tank, wherein said first or second control unit that is not the primary control unit is a secondary control unit and receives flow from said primary control unit, wherein the order of said series flow through said first and second control units may be switched by reversing the position of said valves from open to close and from close to open.
b. setting the position of said valves so that vapor flows first into said primary control unit and secondly flows into said second control unit and operating said apparatus until said primary control unit, now referred to as said spent control unit, has accumulated contaminants requiring its removal and installation;
c. switching the position of said valves, stopping the flow of vapor from said tank to said spent control unit and redirecting said flow of vapor from said tank to said secondary control unit, now referred to as the post-switch primary control unit;
d. detaching said temporary attachment means between said spent control unit and said mobile platform;
e. detaching said temporary means for fluid communication between said spent control unit and said tank and said spent control unit and said post switch primary control unit;
f. removing said spent control unit from said mobile platform;
g. installing a replacement control unit on said mobile platform;
h. securing said temporary means of attachment for said replacement control unit to said mobile platform; and
i. attaching said temporary means of communication between said replacement control unit and said post-switch primary control unit and said replacement control unit and said treated exhaust vent.

14. The apparatus of claim 13 wherein said material capable of removing said contaminants from said vapor is said absorbent material selected from the group consisting of an organic liquid, a caustic solution, or an aqueous solution.

15. The apparatus of claim 13 wherein said contaminant is an organic contaminant and said material capable of removing said contaminant from said vapor is said combination of absorbent and adsorbent material, and where said absorbent material is an organic liquid and said adsorbent material is an activated carbon.

16. The apparatus of claim 14 wherein said adsorbent material capable of removing said contaminant from said vapor is activated carbon.

17. The apparatus of claim 16 wherein said first control unit and said second control unit have a vapor inlet located at a bottom of said first control unit and said second control unit, and a vapor outlet located at a top of said first control unit and said second control unit, where said absorbent material is located in a bottom portion of the said first control unit and said second control unit, and the carbon is located in a top portion of the said first control unit and said second control unit.
